(19) United States
(12) Patent Application Publication
(10) Pub. No.: US 2009/0172109 A1
(43) Pub. Date: Jul. 2, 2009

(54) SYSTEM AND METHOD FOR ENFORCING SINGLE-THREADED CONVERSATIONS

(76) Inventors: Robert Cameron Weir, Westford, MA (US); Patrick Joseph O'Sullivan, Ballsbridge (IE); Barry E. Willner, Briarcliff Manor, NY (US); Edith Helen Stern, Yorktown Heights, NY (US)

Correspondence Address: HOLLAND & KNIGHT, 10 ST. JAMES AVENUE, BOSTON, MA, 02116-3889, US

(21) Appl. No.: 11/966,461

(22) Filed: Dec. 28, 2007

(51) Int. Cl. G06F 15/16

(52) U.S. Cl. 709/206

(57) ABSTRACT

A method and computer program product for enforcing single threaded conversations includes defining a single threaded status for an email chain including one or more emails. If a received email belongs to the email chain, the single threaded status of the email chain is enforced.

### TECHNICAL FIELD

This disclosure relates to communications and, more particularly, to systems and methods for maintaining a single-threaded structure in communications.

### BACKGROUND

Email has become a very common means of communication, allowing easy and quick exchanges of information. The ability to include multiple parties in an email exchange, or conversation, provides a convenient mechanism for collaboration and sharing information locally, as well as globally. However, difficulties may arise when email conversations become multi-threaded, with a single email conversation spawning multiple side conversations. All of the original parties to the email conversation may be included in the side conversations, without regard for whether the side conversations have any relevance to all of the included individuals, or even any relevance to the original subject of the email conversation. In other instances, some of the original participants in the email exchange may be excluded from side conversations in which they may be interested.

Additionally, problems with email collaboration may arise as the number of participants in the conversation increases and the volume of email traffic in the conversation increases. Individuals may reply to earlier emails in the conversation without realizing that others have already addressed the topic. For example, a question may be asked and answered in the email conversation, but an individual not aware that an answer has already been provided may provide a redundant answer. Not only is time wasted researching and composing the later answer, but also by users handling the redundant answer that may not add any additional information over the first answer.

The various problems associated with group email conversations, such as multi-threaded email conversations and redundant replies to on the same topic, may arise without any intent or awareness of the problems by the participants of the email conversation. Further even if there is an awareness of the problem, current email systems lack the ability to implement effective controls for limiting the problems without also limiting the capacity of email as an effective tool for communication and collaboration.

### SUMMARY OF DISCLOSURE

In a first implementation, a method includes defining a single threaded status for an email chain including one or more emails. If a received email belongs to the email chain, the single threaded status of the email chain is enforced.

One or more of the following features may be included. Defining the single threaded status for the email chain may include associating an identifier with each of the one or more emails in the email chain. Further, associating the identifier with each of the one or more emails may include providing an order designation for each the one or more emails in the email chain.

Enforcing the single threaded status of the email chain may include determining if the received email is a most recent email in the email chain. A warning may be provided if the received email is not the most recent email in the email chain. Additionally/alternatively, a pointer may be provided to the most recent email in the email chain if the received email is not the most recent email in the email chain.

Enforcing the single threaded status for the email chain may include preventing replies to the received email if the received email is not the most recent email in the email chain. Further, enforcing the single threaded status for the email chain may include preventing removing a recipient from a reply to the received email. Additionally, enforcing the singled threaded status for the email chain may include associating a subsequent order designation with a reply to the received email. The method may also include determining if the received email is a most recent email in the email chain prior to sending a reply composed offline to the received email.

According to another implementation, a computer program product resides on a computer readable medium having a plurality of instructions stored thereon. When executed by a processor, the instructions cause the processor to perform operations including defining a single threaded status for an email chain including one or more emails. If a received email belongs to the email chain, the single threaded status of the email chain is enforced.

One or more of the following features may be included. The instructions for defining the single threaded status for the email chain may include instructions for associating an identifier with each of the one or more emails in the email chain. Further, the instructions for associating the identifier with each of the one or more emails may include instructions for providing an order designation for each the one or more emails in the email chain.

The instructions for enforcing the single threaded status of the email chain may include instructions for determining if the received email is a most recent email in the email chain. Instructions may also be included for providing a warning if the received email is not the most recent email in the email chain. Additionally/alternatively, instructions may be included for providing a pointer to the most recent email in the email chain if the received email is not the most recent email in the email chain.

The instructions for enforcing the single threaded status for the email chain may include instructions for preventing replies to the received email if the received email is not the most recent email in the email chain. Additionally, the instructions for enforcing the single threaded status for the email chain may include instructions for preventing removing a recipient from a reply to the received email. Furthermore, the instructions for enforcing the singled threaded status for the email chain may include instructions for associating a subsequent order designation with a reply to the received email. The computer program product may also include instructions for determining if the received email is a most recent email in the email chain prior to sending a reply composed offline to the received email.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a threading process and email application coupled to a distributed computing network.

FIG. 2 is a flowchart of a process executed by the threading process of FIG. 1.

FIG. 3 diagrammatically depicts a display screen rendered by the threading process and/or the email application of FIG. 1.

FIG. 4 diagrammatically depicts a display screen rendered by the threading process and/or the email application of FIG. 1.

FIG. 5 diagrammatically depicts a display screen rendered by the threading process and/or the email application of FIG. 1.

FIG. 6 diagrammatically depicts a display screen rendered by the threading process and/or the email application of FIG. 1.

FIG. 7 diagrammatically depicts a display screen rendered by the threading process and/or the email application of FIG. 1.

### DETAILED DESCRIPTION OF THE PREFERRED EMBODIMENTS

### System Overview:

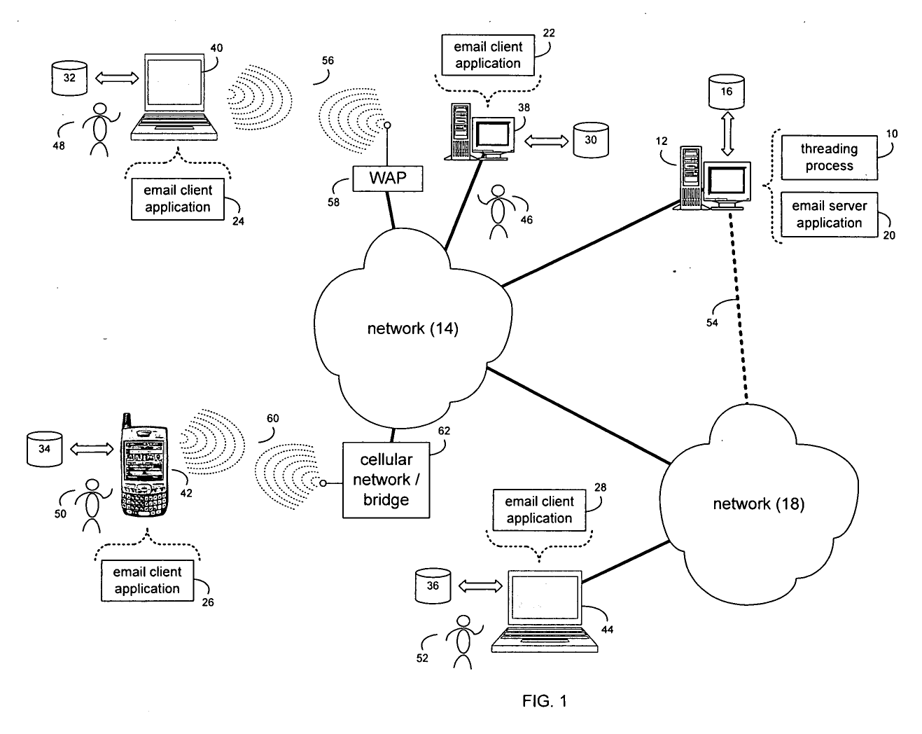

Referring to FIG. 1, there is shown threading process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, the threading process may reside on and may be executed, in whole or in part, by a client electronic device, such as a personal computer, notebook computer, personal digital assistant, or the like.

As will be discussed below in greater detail, threading process 10 may define a single threaded status for an email chain (e.g., an email conversation) including one or more emails. If a received email belongs to the email chain, the single threaded status of the email chain may be enforced. As such, an email chain having a single threaded status may be maintained as a single threaded email chain (i.e., may be maintained as a single threaded conversation).

The instruction sets and subroutines of threading process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute email server application 20, examples of which may include but are not limited to Lotus Domino™ Server and Microsoft Exchange™ Server. Email server application 20 may be a mail transfer agent that may store and route email to one or more email client applications, e.g., email client applications 22, 24, 26, 28, examples of which may include but are not limited to Lotus Notes™ and Microsoft Outlook™. Threading process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

As mentioned above, in addition/as an alternative to being a server-based application residing on server computer 12, the threading process may be a client-side application (not shown) residing on one or more client electronic device 38, 40, 42, 44 (e.g., stored on storage device 30, 32, 34, 36, respectively), and executed by a processor (not shown) and memory architecture (not shown) incorporated into the one or more client electronic devices. The client-side threading process may be a stand alone application that interfaces with an email client application (e.g., email client applications 22, 24, 26, 28), or may be an applet/application that is executed within an email client application. As such, the threading process may be a client-side application, a server-side application, or a hybrid client-side/server-side application, which may be executed, in whole or in part, by server computer 12, and/or one or more of client electronic device (e.g., client electronic devices 38, 40, 42, 44).

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42 notebook computer 44, a data-enabled, cellular telephone (not shown), and a dedicated network device (not shown), for example. Using email client applications 22, 24, 26, 28, users 46, 48, 50, 52 may access email server application 20 and may create, reply to, and forward email messages (“emails”).

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Threading Process:

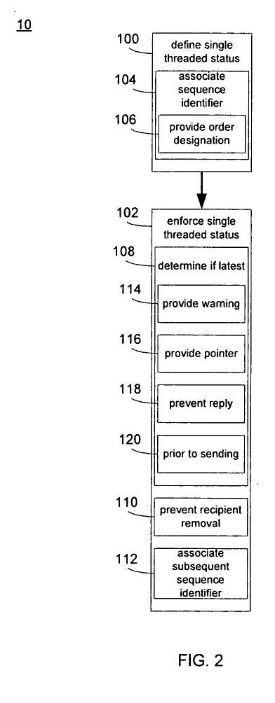

Referring also to FIG. 2, threading process 10 may allow a user to define 100 a single threaded status for an email chain (e.g., an email conversation) including one or more emails. Additionally, if a received email belongs to the email chain, threading process 10 may enforce the single threaded status of the email chain.

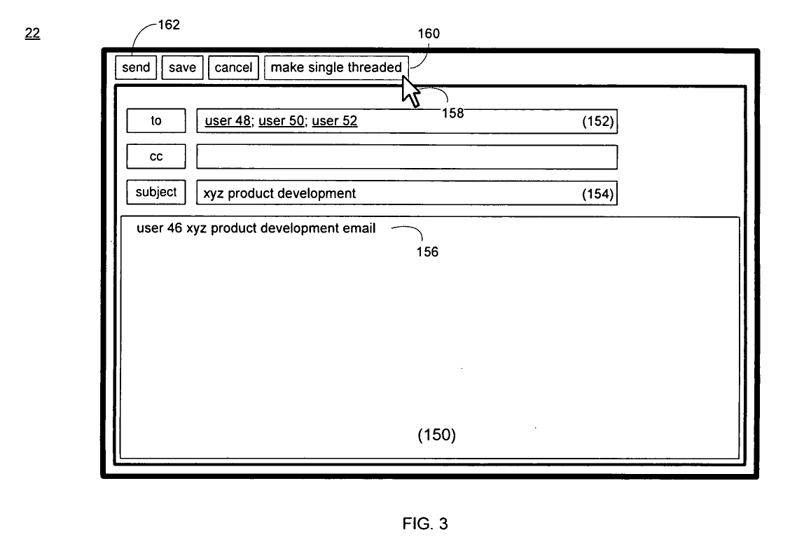

For example, and referring also to FIG. 3, email client application 22 (alone or in combination with one or more of threading process 10, and/or email server application 20) may allow a user (e.g., user 46) to create email 150. Email 150 may include one or more recipients (e.g., user 48, user 50, and user 52). When creating email 150 user 46 may input (e.g., using a keyboard, contacts list, or similar mechanism; not shown) the email addresses of the one or more recipients (namely, user 48, user 50, user 52) in “to” field 152. Similarly, user 46 may define (e.g., by inputting via a keyboard; not shown) a subject of email 150 (e.g., “xyz product development”) in “subject” field 154, and the content of email 150 (i.e., email body 156).

Threading process 10 may allow user 46 to define 100 a single threaded status for an email chain including one or more emails (e.g., including email 150). For example, user 46 may define 100 the single threaded status for the email chain by selecting, via onscreen pointer 158 controlled by a pointing device (e.g., a mouse; not shown), “make single threaded” button 160. User 46 may define 100 the single threaded status for the email chain at any time during the creation of email 150 (e.g., before, during, and/or after defining the recipients of email 150, the subject of email 150, and/or email body 156). User 46 may send email 150 to the defined recipients (e.g., user 48, user 50, user 52) by selecting, via onscreen pointer 158, send button 162.

Defining 100 the single threaded status for the email chain may include associating 104 an identifier with each of the one or more emails in the email chain. For example, the identifier may provide a unique identification for email 150 and/or for the email chain. The identifier associated 104 with email 150 may include a unique identifier of email 150, and may associate email 150 with the email chain. For example, the identifier may include the author of email 150 (e.g., user 46), the subject of email 150 (e.g., xyz product development) and a time-date stamp associated with the time and date that email 150 was sent. Various other identifiers may also be employed, such as a serial number, or similar identifier. As mentioned above, in part, the identifier associated 104 with email 150 (i.e., the first email included in the email chain) may provide a unique identifier of the single threaded email chain. The one or more emails of the email chain may be identified as belonging to the email chain based upon, at least in part, the unique identifier of the single threaded email chain.

Further, associating 104 the identifier with each of the one or more emails may include providing 106 an order designation for each one of the one or more emails in the email chain. Continuing with the above-stated example, email 150 created by user 46 may be the first email in the single threaded email chain. As such, threading process 10 may provide 106 an order designation indicating that email 150 created by user 46 is the first email in the email chain. The identifier including the author of the email, the subject of the email, and a time-date stamp may provide 106 an order designation (e.g., later emails in the email chain may have respectively later time-date stamps). Similarly, any serialized naming or numbering scheme that allows a determination of relative order may provide 106 an order designation.

Threading process 10 may associate 104 the identifier with the email chain at the time the email is sent, and/or at the time the email is composed. The associated 102 identifier, e.g., which may identify email 150 as belonging to a single threaded email chain and may identify the relative order of email 150 within the email chain, may be stored on a server (e.g., stored on storage device 16 of server computer 12, upon which email server application 20 resides). Additionally/alternatively, the associated 104 identifier may be embedded within email 150. Further, an indicator that email 150 is an email of a single threaded email chain may be embedded within, and may travel with, email 150, and the associated 104 identifier may be stored on server computer 12.

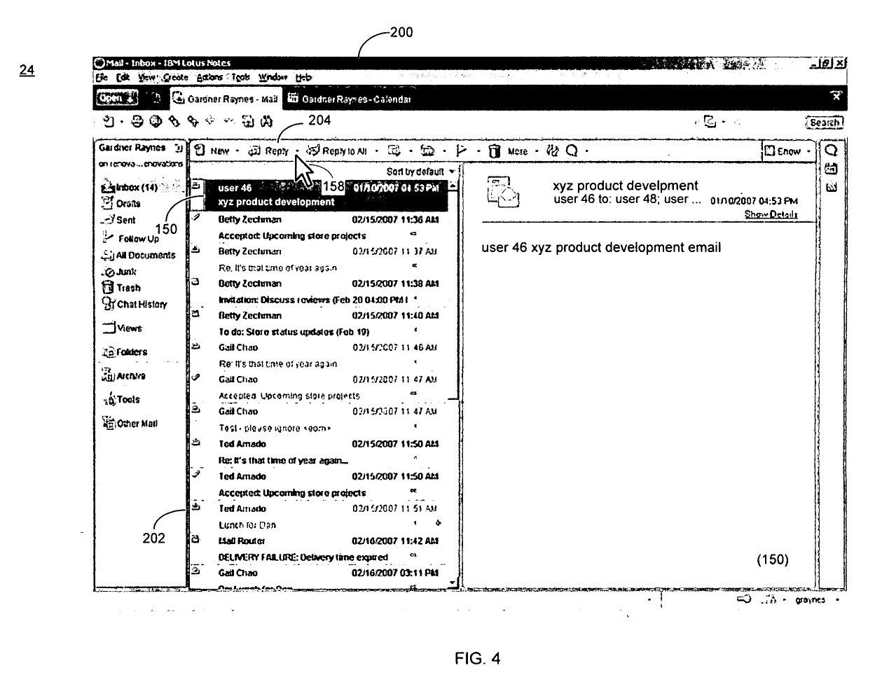

Enforcing 102 the single threaded status of the email chain may include determining 108 if the received email is a most recent email in the email chain. Continuing with the above-stated example, and referring also to FIG. 4, email client application 24 may render display window 200 including email 150 received by user 48 from user 46. As mentioned above, email 150 may include an indicator of the single threaded status of the email chain including email 150. In response to, at least in part, the presence of the indicator of single threaded status of the email chain, threading process 10 may determine 108 if email 150 received by user 48 is the most recent email in the email chain.

For example, threading process 10 may search user 48's email inbox (e.g., including emails displayed in inbox pane 202 of display window 200) for other emails included within the email chain, e.g., based upon, at least in part, the unique identifier of the email chain (e.g., the identifier associated 104 with email 150 when it was sent by user 46). Additionally/alternatively, threading process 10, email server application 20, and/or email client application 24 may query server computer 12 (upon which the identifier associated 104 with email 150 sent by user 46 may reside) to determine if the order designation provided 106 for email 150 corresponds to the most recent email in the email chain. Threading process 10 may determine 108 if email 150 is the most recent email in the email chain when email 150 is received and/or when email 150 is opened, viewed, and/or responded to by user 48.

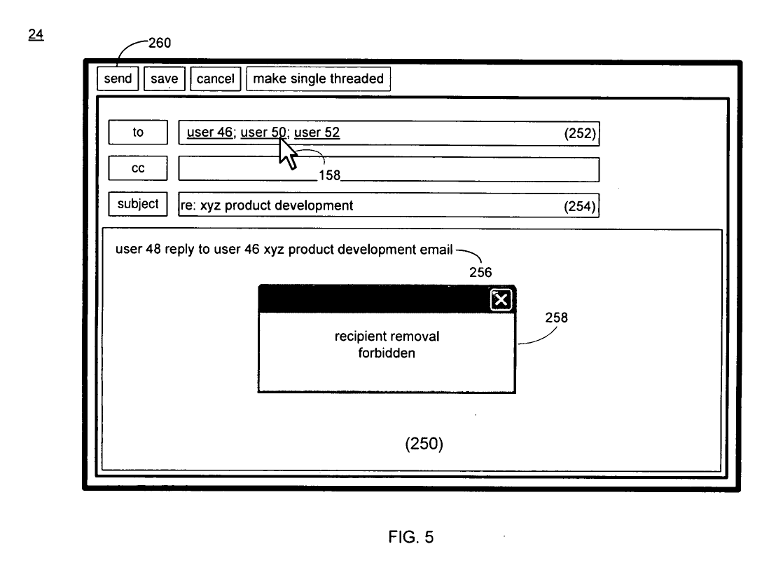

User 48 may reply to email 150, e.g., by selecting, via onscreen pointer 158, reply button 204 in display window 200. Threading process 10 may again (and/or for the first time) determine 108 if email 150 is the most recent email in the email chain. Further, and referring also to FIG. 5, selecting reply button 202 may result in email client application 24 (alone or in combination with one or more of threading process 10, and/or email server application 20) allowing user 48 to create reply email 250. Reply email 250 may include as recipients (e.g., in “to” field 252) the sender of email 150 (e.g., user 46) and the other recipients (e.g., user 50, user 52) of email 150. Additionally, email 250 may include a default subject “re: xyz product development” in subject field 254. User 48 may input (e.g., via a keyboard; not shown) desired message content of email 250 (e.g., body 256 of the email message).

Enforcing 102 the single threaded status for the email chain may include preventing 110 removing a recipient from a reply to the received email. Continuing with the above stated example, email 250 may include one or more recipients (e.g., user 46, user 50, user 52). In composing email 250 in reply to email 150, user 48 may attempt to remove user 50 as a recipient (e.g., by deleting user 50 from “to” field 252). Attempting to remove user 50 as a recipient may result in threading process 10 and/or email client application 24 rendering “recipient removal forbidden” warning 258. Additionally/alternatively, threading process 10 and/or email client application 24 may merely disable the delete capability with respect to recipients in “to” field 252. As such, threading process 10 may prevent 110 user 48 removing user 50 as a recipient of email 250.

Enforcing 102 the single threaded status of the email chain may be facilitated by placing a lock on the single threaded email chain during composition of an email in the single threaded email chain. Once a user has begun composing an email in the single threaded email chain, the lock may prevent other users from composing an email in the single threaded email chain. For example, while user 48 is composing email 250 (e.g., once user 48 selects reply button 204) in reply to email 150, threading process 10 and/or email server application 20 may prevent another user (e.g., user 46, user 50, user 52) from composing or sending a reply to email 150. The lock may be released when email 250 is sent (e.g., in response to user 48 selecting send button 260. Once the lock is released, one or more other users may compose an email in the email chain (of which email 250 may now be the most recent email).

Additionally/alternatively, rather than placing a lock on the single threaded email chain, threading process 10 may verify that an email being responded to is still the most recent email in the email chain prior to sending a response email. Continuing with the above-stated example, when user 48 selects (via onscreen pointer 158) send button 204, threading process 10 may determine 108 if email 150 (i.e., the email to which email 250 is a reply) is the most recent email in the email chain. If email 150 is the most recent email in the email chain, threading process 10, email client application 24, and/or email server application 20 may allow email 250 to be sent to the defined recipients. If, on the other hand, threading process 10 determines 108 that email 150 is not the most recent email in the email chain, threading process (alone or in combination with email client application 24 and/or email server application 20) may prevent email 250 from being sent, and/or may generate a warning that the email being responded to (i.e., email 150) is no longer the most recent email in the email chain.

Additionally, enforcing 102 the single threaded status of the email chain may include associating 112 a subsequent order designation with a reply to the received email. Continuing with the above stated example, threading process 10 may associate 112 a subsequent order designation with email 250. The associated 112 subsequent order designation may indicate a relative position of email 250 in the email chain (e.g., that email 250 is the email immediately following email 150 in the email chain). Additionally, the subsequent order designation may indicate that email 250 is part of the specific single threaded email chain. For example, the subsequent order designation may include a reference to email 150 (i.e., the first email in the single threaded email chain). The reference to email 150 may include, for example, the author, subject, and time-date stamp associated with email 150. For example, the subsequent order designation may include a time-date stamp associated with the time and date email 250 was sent. Various other information may also, or alternatively, be included in the subsequent order designation associated 112 with email 250.

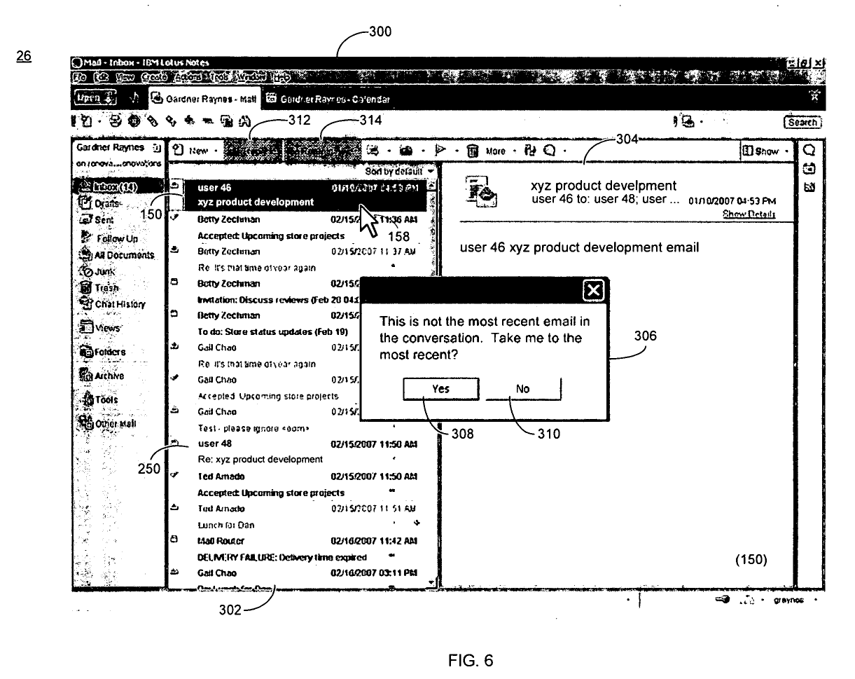

Continuing with the above-stated example and referring also to FIG. 6, email client application 26 may render display screen 300 including, but not limited to, inbox 302 and preview pane 304. Inbox 302 may include email 150 (also displayed in preview pane 304) received by user 50 from user 46, and email 250 received by user 50 from user 48. User 50 may select, e.g., via onscreen pointer 158 email 150 in inbox 302, resulting in email client application 26 rendering email 150 in preview pane 304. When user 50 selects email 150, threading process 10 (alone and/or in conjunction with one or more of email client application 26 and email server application 20) may determine 108 if email 150 is the most recent email in the single threaded email chain. Continuing with the above stated example, email 250 may be most recent email in the email chain. As such, email 150 may not be the most recent email in the email chain.

Threading process 10 may provide 114 a warning if the received email is not the most recent email in the email chain. With continuing reference to FIG. 6, upon determining 108 that email 150 is not the most recent email in the email chain may result in threading process 10 and/or email client application 26 rendering popup 306. Popup 306 may indicate that email 150 is not the most recent email in the email chain (i.e., in the single threaded conversation). Additionally/alternatively, threading process 10 may provide 116 a pointer to the most recent email in the email chain if the received email is not the most recent email in the email chain. For example, as shown in FIG. 6, popup 306 may offer to direct user 50 to the most recent email in the email chain. User 50 may select, via onscreen pointer 158, “yes” button 308 resulting in threading process 10 and/or email client application 26 rendering email 250 (i.e., the most recent email in the email chain). Alternatively, user 50 may select, via onscreen pointer 158, “no” button 310 to decline being directed to email 250.

Enforcing 102 the single threaded status for the email chain may include preventing 118 replies to the received email if the received email is not the most recent email in the email chain. For example, as shown in FIG. 6, threading process 10, email client application 26, and/or email server application 20 may prevent 118 replies to email 150 by disabling reply features, e.g., as indicated by grayed-out reply button 312, and reply to all button 314. While not shown, threading process 10 may prevent 118 replies to email 150 by providing an error popup, declining to process the reply request, or the like. Still further, threading process 10 may allow a reply to email 150 to be sent, and may include a notification to recipients of the reply that the reply is not a reply to the latest email in the email chain (i.e., not a reply to email 250).

Continuing with the above-stated example, user 52 may receive, via email client application 28 and/or email server application 20, email 150 sent by user 46. Email 150 may be received by email client application 28 while notebook computer 44 is online (e.g., while email client application 28 is connected, via network 18 and/or network 14, to email server application 20). A copy of email 150 may be locally saved on storage device 36 coupled to notebook computer 44. After receiving and locally storing a copy of email 150, user 52 may go offline, (e.g., may disconnect email client application 28 from email server application 20).

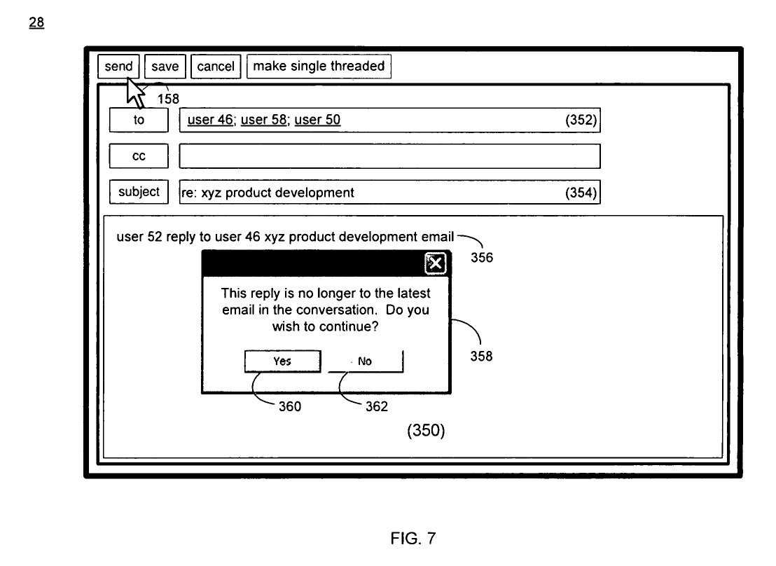

Referring also to FIG. 7, email client application 28 may allow user 52 to compose email 350 in reply to email 150 while email client application 28 is offline (e.g., not communicating with email server application 20), for example, by selecting a reply option in a display screen (not shown) rendered by email client application. Similar to previous description, reply email 350 may include as recipients (e.g., in “to” field 352) the sender of email 150 (e.g., user 46) and the other recipients (e.g., user 48, user 50) of email 150. Additionally, email 350 may include a default subject “re: xyz product development” in subject field 354. User 52 may input (e.g., via a keyboard; not shown) desired message content (e.g., email body 356). While email client application 28 is offline, email 350 cannot be sent, but may be saved locally (e.g., on storage device 36) to be sent at a later time (e.g., when email client application 28 is again connected to email server application 20).

Threading process 10 may determine 108 if the received email is a most recent email in the email chain prior to sending 120 a reply composed offline to the received email. Continuing with the above stated example, when email client application 28 reconnects to email server application 20, email 350 may be sent. However, during the time period during which email client application 20 was offline, one or more emails may have been added to the email chain (e.g., other users may have composed and sent one or more emails in the email chain). As such, email 150, to which email 350 is a reply, may not be the most recent email in the email chain when email client application 28 reconnects to email server application 20. Prior to sending 120 email 350, threading process 10 may determine 108 if email 150 is the most recent email in the email chain. Threading process 10 may determine 108 if email 150 is the most recent email in the email chain, for example, when email client application 28 reconnects to email server application 20, and/or when user 52 attempts to send email 350.

Continuing with the above-stated example, user 48 may have composed and sent email 250 in reply to email 150 while email client application 28 was offline. As such, when email client application reconnects to email server application 20, email 150 may no longer be the most recent email in the email chain. In response to determining that email 150 is no longer the most recent email in the email chain, threading process 10 and/or email client application 28 may render popup 358, including a warning that user 52 is no longer responding to the latest email in the conversation. Furthermore, threading process 10 may decline to send email 350, as email 350 is no longer in reply to the latest email in the email chain.

Alternatively, threading process 10 may allow user 52 to send email 350 even though email 350 is no longer in reply to the most recent email in the email chain. For example, user 52 may select, via onscreen pointer 158, yes button 360 to send email 350 even though it is not a reply to the most recent email in the email chain. Alternatively, user 52 may select, via onscreen pointer 158, no button 362 to cancel sending email 350. If user 52 chooses to send email 350 (e.g., by selecting yes button 360), threading process 10 may provide an indication that email 350 is out of sequence (i.e., is not in reply to the most recent email in the email chain). The indication may be perceivable by recipients of email 350 (e.g., user 46, user 48, user 50). Additionally, as discussed above, threading process 10 may associate 112 a subsequent order designation with email 350. The subsequent order designation may indicate that email 350 is not in reply to the most recent email in the email chain.

A number of implementations have been described. Nevertheless, it will be understood that various modifications may be made. Accordingly, other implementations are within the scope of the following claims.

What is claimed is:

1. A method comprising:
defining a single threaded status for an email chain including one or more emails; and
if a received email belongs to the email chain, enforcing the single threaded status of the email chain.

2. The method of claim 1, wherein defining the single threaded status for the email chain includes associating an identifier with each of the one or more emails in the email chain.

3. The method of claim 2, wherein associating the identifier with each of the one or more emails includes providing an order designation for each the one or more emails in the email chain.

4. The method of claim 1, wherein enforcing the single threaded status of the email chain includes determining if the received email is a most recent email in the email chain.

5. The method of claim 4, further including providing a warning if the received email is not the most recent email in the email chain.

6. The method of claim 4, further including providing a pointer to the most recent email in the email chain if the received email is not the most recent email in the email chain.

7. The method of claim 4, wherein enforcing the single threaded status for the email chain includes preventing replies to the received email if the received email is not the most recent email in the email chain.

8. The method of claim 1, wherein enforcing the single threaded status for the email chain includes preventing removing a recipient from a reply to the received email.

9. The method of claim 1, wherein enforcing the singled threaded status for the email chain includes associating a subsequent order designation with a reply to the received email.

10. The method of claim 1, wherein enforcing the single threaded status for the email chain includes determining if the received email is a most recent email in the email chain prior to sending a reply composed offline to the received email.

11. A computer program product residing on a computer readable medium having a plurality of instructions stored thereon which, when executed by a processor, cause the processor to perform operations comprising:
defining a single threaded status for an email chain including one or more emails; and
if a received email belongs to the email chain, enforcing the single threaded status of the email chain.

12. The computer program product of claim 11, wherein the instructions for defining the single threaded status for the email chain include instructions for associating an identifier with each of the one or more emails in the email chain.

13. The computer program product of claim 12, wherein the instructions for associating the identifier with each of the one or more emails include instructions for providing an order designation for each the one or more emails in the email chain.

14. The computer program product of claim 11, wherein the instructions for enforcing the single threaded status of the email chain include instructions for determining if the received email is a most recent email in the email chain.

15. The computer program product of claim 14, further including instructions for providing a warning if the received email is not the most recent email in the email chain.

16. The computer program product of claim 14, further including instructions for providing a pointer to the most recent email in the email chain if the received email is not the most recent email in the email chain.

17. The computer program product of claim 14, wherein the instructions for enforcing the single threaded status for the email chain include instructions for preventing replies to the received email if the received email is not the most recent email in the email chain.

18. The computer program product of claim 11, wherein the instructions for enforcing the single threaded status for the email chain include instructions for preventing removing a recipient from a reply to the received email.

19. The computer program product of claim 11, wherein the instructions for enforcing the singled threaded status for the email chain include instructions for associating a subsequent order designation with a reply to the received email.

20. The computer program product of claim 11, wherein the instructions for enforcing the single threaded status for the email chain include instructions for determining if the received email is a most recent email in the email chain prior to sending a reply composed offline to the received email.
